(19) United States
(12) Patent Application Publication
(10) Pub. No.: US 2003/0076812 A1
(43) Pub. Date: Apr. 24, 2003

(54) Method for optimizing the random access procedures in the cdma cellular networks

(76) Inventor: Rosella De Benedittis, Milano (IT)

Correspondence Address: BIRCH STEWART KOLASCH & BIRCH, PO BOX 747, FALLS CHURCH, VA, 22040-0747, US

(21) Appl. No.: 10/204,673

(22) PCT Filed: Feb. 22, 2001
(86) PCT No.: PCT/EP01/02049

(51) Int. Cl. H04J 3/06

(52) U.S. Cl. 370/350

(57) ABSTRACT

The disclosed invention is referred to a method for optimising the random access procedures in third generation CDMA cellular telephony systems. The particular embodiment of the example concerns a TD-SCDMA-TDD synchronous realization. The disclosed procedure includes a preliminary part charged to the network (BSSC, MSC) only for establishing the following associations between the configuration parameters of the involved physical channels:

one signature burst (SYNC1) is associated to one forward access channel (P-FACH) only, in order to avoid any, ambiguity in the mobile stations about where to look for the expected acknowledgement from the network;

one random access common channel (P-RACH) is associated to one forward access channel (P-FACH) only, in order to reduce collision on the latter (P-RACH);

one access grant channel (P/S-CCPCH, AGCH) only is associated to one random access common channel (P-RACH), in order to avoid any ambiguity in the mobile stations about where to look for the expected answer from the network with the indication of the dedicated service channels (DPCH); and

each complete associative link binding the involved physical channels is included in the system information and broadcasted into the serving cell to be read by the mobile stations (MS, UE) when entering an actual part of the procedure charged to exchange protocol messages with the network (BSSC, MSC) through said associative links that being signalling at once to the mobile stations the route towards the services offered by the network, simplifying the access procedure consequently.

Suitable groupings among: Downlink pilot sequences, Uplink pilot sequences, scrambling codes, basic midambles, are carried out in a cell-discriminating way and broadcasted into the cell to simplify the serving cell selection procedure (FIG. 1).

### FIELD OF THE INVENTION

This invention relates to the radio mobile telephony field, and more particularly to a method for optimising the random access procedures in the CDMA cellular networks.

In the field of the invention a lot of research and development efforts have been carried out all in the world and in particular in Europe to standardise and put into operation a so-called third generation (3G) cellular system of UMTS (Universal Mobile Telecommunication System) type, characterized by CDMA (Code Division Multiple Access) multiple access technique. As known, CDMA consists in multiplexing each data symbol to be transmitted with a low symbol rate with an set of pseudo-noise code sequences (chip) with higher rate (the chip rate), to spread over a common wide spectrum the information originated from a plurality of users. The spreading code sequences being reciprocally orthogonal, namely with negligible cross-correlation and good auto-correlation, to get subsequent discrimination between the various users entering the transmission band. Accordingly, the spread spectrum receiver demodulates the reception signal and reconstructs the original data sequences of the various users by effecting a temporal correlation between the demodulated signal and a local copy of the set of code sequences used by the transmitter. From the mathematical correlation each user obtains its original data sequence at the peak level, accordingly distinguished it from noise and interference and from the other sequence that will be perceived like a white noise.

With respect to the traditional narrow band systems the spread spectrum technique supports users with higher transmission bit-rate either in symmetric or asymmetric configuration as far as concerns uplink and downlink disposable band, besides offering the opportunity to trade individual band with multiplexing grade. CDMA systems have the additional advantage, strongly appreciated in cellular ambit, to be quite insensitive to Rayleigh selective fading caused by multiple reflections along the air path of the transmitted signal, that because the spectral fraction concerned by the strong fading is only a very small part of the total spectrum occupied by the effective signal.

### BACKGROUND ART

Patent application PCT/EP00/02671 for an invention of the same Assignee seems to be the nearest prior art. The relevant claim 1 of this citation recites textually: “A method for equalising the propagation delays and optimising the power level in a mobile station accessing network services on a common channel, in the third generation of cellular telephony systems based on a Code Division multiple Access, or CDMA, and Time Division Duplex—Time Division Multiple Access, or TDD-TDMA technique, and comprising at least one base station (BS) and at least one mobile station (MS), and wherein provision is made for the transmission of signals. organized in frames and in multiframes, also containing a correlation word called <<signature burst>> which enables the network to calculate the timing and power level of the signal received, characterized in that it comprises a plurality of temporally distinct steps for the optimization of the <<frame synchronization>> and <<power level>> parameters during the procedure for accessing network services by a mobile station (MS) and in particular:

In the first step said at least one mobile station (MS) uses signature bursts to obtain the correct frame timing and correct power level, with which to access the common channel to send the network its access request.

In the second step, said at least one mobile station (MS) verifies and settles the frame timing and power level parameters, again sending a signature burst, before transmitting on the dedicated resource which it has been assigned by the network.”

The wording of the above claim 1 clearly addresses the cited invention towards the TDMA-CDMA-TDD mobile radio telephony systems which are distinguished from the GSM and other FDD (Frequency Division Duplexing) systems mainly by the presence of a signature burst into the basic frame, expressly provided for uplink synchronization. It's useful to remember that a signature burst does not carry any information or high-level message but only a correlation word that allows the network to calculate the timing and power level of the signal received and to correct it accordingly. From the above claim 1 descends that the main purpose of the cited invention is just that to deploy the network access procedure faced to the optimization of the “power level” and “frame synchronization” parameters in a particularly critical context where a closed ring control mechanism is still absent. This purpose is met by the introduction of two distinct uplink synchronization steps into the access procedure.

The citation further outlines that by using of shared radio resources during the access procedure collisions may happen on common access channel, i.e. those events where various users simultaneously access the same radio resource. High collision probability means waste of spectrum resources, as collided bursts have to be retransmitted causing interference increase within the system and traffic capacity and signal quality being reduced consequently, specially in a CDMA system. So additional technical problem faced by the invention disclosed in the PCT/EP00/02671 application is that to limit as much as possible the collision events on a common access channel P-RACH shared among all the requesters. For this aim the suggestion is that of either explicitly transmitting the RACH configuration parameters (in terms of time slot/frequency/coding) through signalling, or taken implicitly from the mobile, for example because the association is known beforehand between the RACH channel to be used and a channel P-FACH via which the mobile has received from the network the confirmation message to the signature burst.

Further additional technical problem faced by the invention of the citation is that to limit the probability of collisions in use of the signature bursts. In the citation is said that numerous signature bursts with excellent auto and cross correlation properties can be sent in parallel by numerous mobile stations and correctly decoded by the network. Secondly, the network can answer numerous requests simultaneously, either by using numerous physical channels, code division type for example, or using a single resource in which to house a multiple answer message. A suggestion for this aim is possible if it is established that for certain services (such as, for example, emergency calls and/or Handover requests) it is possible to send the signature burst in certain frames only of the multiframe (for example, the even frames), whereas for all the other services, the supplementary frames are allowed, then the probability of collisions in use of the signature bursts can be further reduced and the quality offered to the services accordingly improved (for example, by improving the probability of success for handovers).

### OUTLINED TECHNICAL PROBLEM

The invention disclosed in the mentioned PCT/EP00/02671 application advantageously solves the outlined problem of synchronization in time and power the transmission bursts of a mobile accessing first time the network. The same document further discloses how to avoid collision on the common random access channel P-RACH and, under particular circumstances, by using the signatures. Nevertheless other problems out of synchronization and collisions arise in a TD-CDMA-TDD scenario because of its articulate access procedure, but they are not completely perceived and solved by the preceding invention of the same Assignee.

The known access procedure of the citation is detailed by the following steps, only fulfilled after a preliminary downlink synchronization for decoding the broadcast system information:

a) mobile sends a signature in uplink and waits for the system information on the broadcast common channel BCCH;

b) mobile listens the system information and decodes the configured parameters of a P-FACH channel carrying the network acknowledgement to the previous signature, plus a power and time control correction message;

c) mobile accesses the configured P-FACH channel and performs synchronization in power and time, in the meanwhile it decodes a message whose content corresponds to the configured parameters of a P-RACH access channel to which address the access burst;

d) mobile accesses the configured P-RACH channel and performs a channel request to the system services;

e) mobile listens the system information and decodes the configured parameters of a Primary or Secondary Common Control Physical Channel, P/S-CCPCH, which bring an Access Grant logical Channel, AGCH, containing the network answer to any correctly detected, and of course accepted by the system, channel request message. The answer of the network includes the identity of the dedicated channel to the accepted request;

f) mobile decodes the AGCH channel content and performs the second step of the access procedure by sending an assigned signature burst for time and power synchronisation before entering the dedicated mode.

The above access procedure appears cumbersome at glance because of the continuous waiting for listening and decoding the system information. The time spent, on average, by the mobiles before entering the assigned channels undergoes a remarkable delay which worsen the 3G traffic capacity.

Furthermore, as more than one P-FACH channel bringing the acknowledgements to the signatures and more than one CCPCH channel carrying the AGCH grant messages can be configured per cell, on the basis of the traffic foreseen, the accessing mobile station will face the problem to know from which P-FACH channel has to expect the acknowledgement message and from which P/S-CCPCH physical channel has to expect the AGCH grant message.

The just outlined technical problem reveals an aspect that is somehow opposite to avoid collisions on the P-RACH access channel, as per the mentioned prior art. In fact, generally speaking, a collision event on a common channel involves many mobiles transmitting at the same time towards a unique channel whose identity is known, while the case outlined involves a single mobile faced to many possible sending channels whose identity is unknown and shall be signalled consequently. Once the identity of the true sending channel becomes known the relation between the mobile station and the transmitting channel is one to one and collisions don't happen consequently. In the light of the preceding considerations it can be concluded that the teaching of the prior art, if ever it could appear similar at first analysis, in reality it presupposes the contrary departure.

### PURPOSES OF THE INVENTION

The main purpose of the present invention is that to indicate an optimised random access procedure suitable for accessing a TD-CDMA cellular network by minimising the overall time and effort spent before entering the dedicated channel.

Further purpose of the invention is that to indicate an optimised way to assign everywhere in the system uplink and downlink synchronization sequences, as well as midambles and scrambling codes for cell discrimination.

### SUMMARY AND ADVANTAGES OF THE INVENTION

To achieve said purposes the subject of the present invention is a random access procedure in a TD-CDMA network, as disclosed in claim 1.

The claimed solution essentially consists in creating complete associative links of the following type:

SYNC1→P-FACH→P-RACH→P/S-CCPCH

where SYNC1 is one out of eight signature bursts assigned to the serving cell, and P/S-CCPCH is a common physical channel advantageously configured both for the transport of AGCH message and the 2^{nd} step signature acknowledgement. The depicted link is submitted to the following restrictions:

The mapping must associate each one of 8 SYNC1 sequences to a channel P-FACH. Each P-FACH channel must be the destination of one SYNC1 signature at least.

The mapping from P-FACH to P-RACH channel must create an association with a P-RACH channel that has been configured. Each configured P-RACH channel must be the destination of at least one P-FACH.

The mapping from P-RACH to P/S-CCPCH channel must create an association with a P/S-CCPCH channel that has been configured and shall carry an AGCH logical channel. Each configured P/S-CCPCH channel shall represent the destination of the mapping of at least a P-RACH channel.

The overall information for defining all the different associative links resulting from the invention is included among the system information broadcast on BCCH channel; therefore a complete link is known by the mobile and by the network even before establishing a connection. The solution proposed by the present invention has the advantage to avoid useless efforts and delays during the access procedure, otherwise caused by the systematic listening the system information. In particular the proposed channel concatenation allows to simplify the channel detection in the mobile station, as it always knows from which common physical channel P-FACH and P/S-CCPCH to wait for the expected network answers.

Obviously the preceding advantages are maintained, in particular those of:

optimising the access to shared channels P-RACH, as the network knows in advance which physical channel will be selected by the mobile station for the next transmitted message (Channel Request).

Limiting collisions on the shared channels (P-RACH) at the benefit of the incoming mobile stations as well as of the other users which may be co-located with that specific shared channel.

The Applicant emphasises the originality of the proposed solution by the comparison between the actual teaching and that of one's own preceding application numbered PCT/EP00/0267, in which ad hoc solutions to speed up and lighten mobile station accesses were not explicitly thought. The main suggestion thereof was in fact directed to the only purpose of avoiding collisions on a common access RACH channel, achieved by transmitting the RACH configuration parameters through signalling, but so doing the time spent at regard inevitably prolonged the access procedure. In an alternative embodiment the configured RACH parameters were taken implicitly from the mobile because of a beforehand known association between the RACH channel to be used and a channel P-FACH via which the mobile had received from the network the confirmation message to the signature burst. This last suggestion was still for the only aim to avoid collisions on the RACH channel, because nothing was said about the opportunity of shortening and alleviate the complete access procedure both for the collided and not collided mobile stations. This latter highlighted problem is solved by the invention in subject through a full concatenate link between all the channels involved before entering the dedicated channel, partial association is not contemplated because uneffective. Thanks to the full channel concatenation which characterises an associative link the random selection of a specific SYNC1 signature, completed by the mobile station, will determine all the other channels involved in the access procedure. This original feature is impossible to obtain for the alternative embodiment of the prior art, because deprived of a full concatenated link between all the involved channels.

Additional improvements in the direction of the problem solved by the invention in subject will be detailed later on and mainly consist of predisposing suitable cell-discriminating code links of the following type:

Downlink pilot sequence→Uplink pilot sequence group→→scrambling code group→basic midamble group.

whose constitutive codes are broadcast on the BCCH channel. This second gender of links allows the mobile station to simplify the cell selection procedure which is preliminary to any subsequent access procedures.

### BRIEF DESCRIPTION OF THE DRAWINGS

Further objects and advantages of the present invention will be made clear by the following detailed description of an embodiment thereof and the annexed drawings given for purely non-limiting explanatory purposes and wherein:

FIG. 1 shows a block diagram of an UMTS (3G) mobile radio telephony system;

FIG. 2 shows a hierarchy of sequential frames of the signal transmitted to the radio interface Uu of the mobile radio telephony system of FIG. 1;

FIG. 3a shows a basic frames belonging to the hierarchy of FIG. 2;

FIG 3b shows the structure of the DwPTS burst, included in the basic frame of FIG. 3a;

FIG. 3c shows the structure of the UpPTS burst included in the basic frame of FIG. 3a;

FIG. 3d shows a general structure of bursts Ts0, . . . Ts6 contained in the basic frame of FIG. 3a;

FIG. 3e shows an actual structure of bursts Ts0, . . . Ts6 contained in the basic frame of FIG. 3a;

FIG. 4 shows a 3G system cluster of cells numbered in base to the different available downlink pilot bursts DwPTS indicated in APPENDIX APP2;

FIG. 5 shows a representation of physical and logic channels relevant to a basic frame of FIG. 3a;

FIG. 6 shows a block diagram of a protocol having more hierarchical levels for governing the operation of the 3G mobile radio telephony system of FIG. 1;

FIG. 7 shows a message sequence chart relevant to an originated call protocol limited to the exchange of messages at the interface radio Uu of the 3G mobile radio telephony system in which the present invention is applied;

FIG. 8 shows a message sequence chart relevant to an ended call protocol similar to the originating call;

APPENDIX APP1 shows 6 Tables: TABLE 1-A1 to TABLE 6-A1, specifying some physical and functional characteristics of the radio interface Uu of the 3G mobile radio telephony system of the present invention;

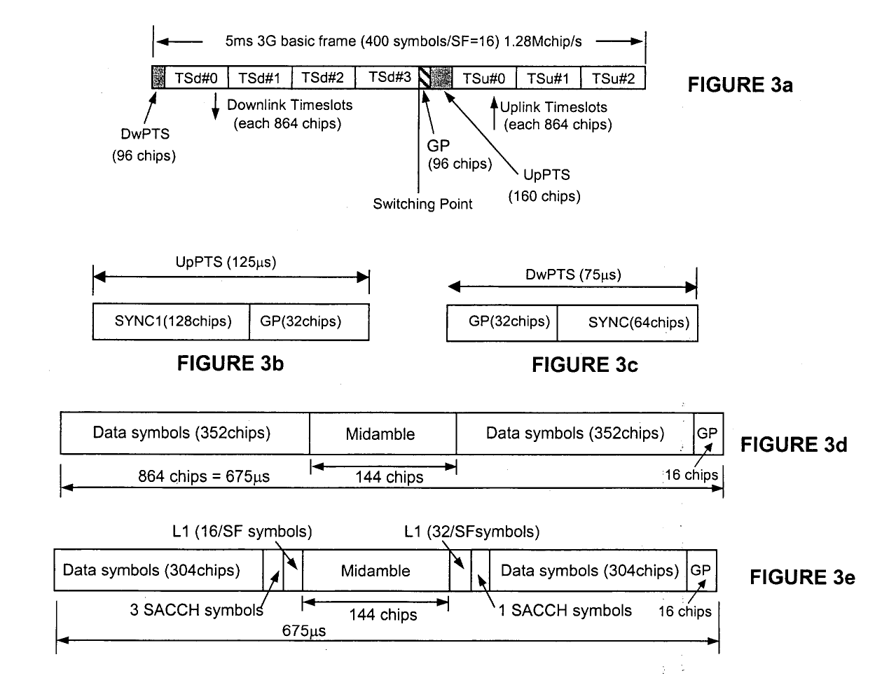

APPENDIX APP2 includes two Tables: the first TABLE 1-A2 indicates a criterion employed in a 3G cellular system to share among the different cells of the cluster the different available downlink pilot bursts DwPTS of FIG. 3b, together with groups of SCRAMBLING CODEs and groups of midambles that can be referred to the bursts of FIGS. 3d and 3e. The second TABLE 2-A2 completes the previous criterion by indicating the available groups of uplink pilot bursts UpPTS of FIG. 3c;

APPENDIX APP3 includes three Tables: namely TABLE 1-A3, 2-A3, 3-A3 indicating various criteria for mapping logical channels into physical channels.

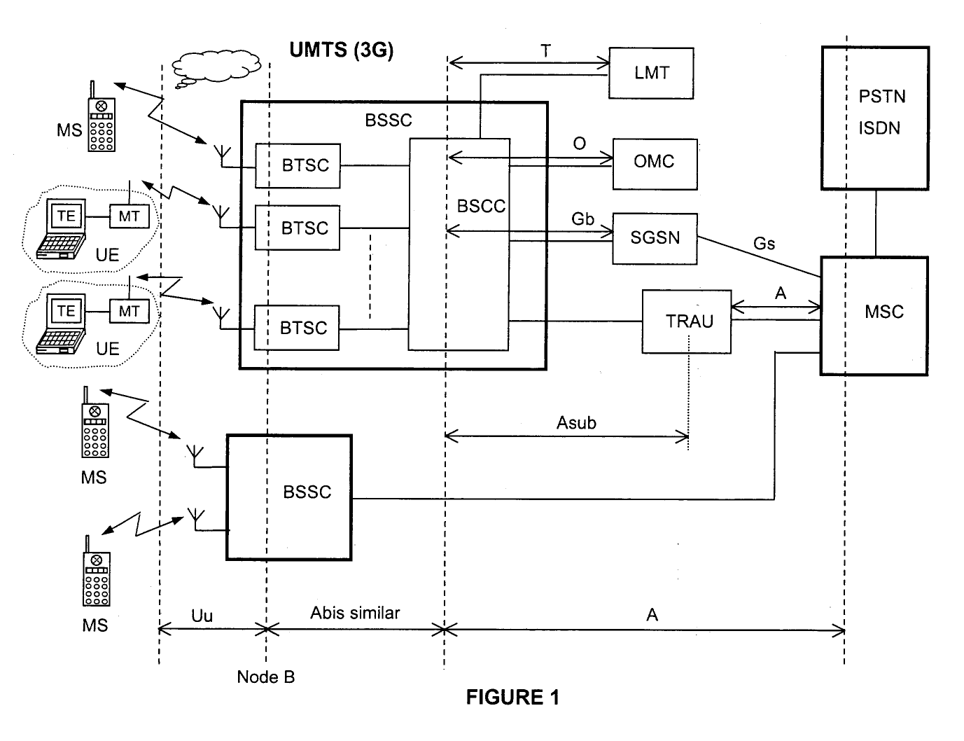

APPENDIX APP4 shows a TABLE 1-A4 that includes a very general functional description of level 2 protocols used in 3G mobile radio telephony system of FIG. 1, and a similar TABLE 2-A4 relevant to level 3 protocols.

### DETAILED DESCRIPTION OF AN EMBODIMENT OF THE INVENTION

FIG. 1 shows a brief but clear block diagram of the functional architecture of an UMTS mobile radio telephony system (3G) where the invention that shall be described resides. In FIG. 1, both portable telephone sets MS (Mobile Stations or Mobile Units), also vehicular ones, and portable User Equipment units UE, are radio connected with relevant TRX transceivers (non-visible in the figure) belonging to relevant base transceiver stations BTSC (Base Transceiver Station for CDMA) spread on the territory. Each portable User Equipment unit UE is constituted of a Terminal Equipment unit TE (typically a Personal Computer) connected to a Mobile Terminal unit (typically a telephone set) for data transmission in packet format.

Each TRX is connected to a group of antennas whose configuration assures uniform radio coverage of the cell served by the BTSC, also termed Node B. A group of N adjacent cells, that altogether engage all the carriers available to the mobile radio service, is called cluster; the same carriers can be re-used in contiguous clusters. More base stations of the BTSC type are connected through physical carrier to a common base station controller denoted BSCC (Base Station Controller for CDMA). More BTSC altogether, governed by a BSCC forms a functional subsystem defined BSSC (Base Station System for CDMA). More BSSC (BSCC) are connected to a mobile switching centre MSC (Mobile Switching Centre), directly or through a TRAU block (Transcode and Rate Adaptor Unit) that enables the submultiplexing of 16 or 8 kbit/s channels on the 64 kbit/s connection lines, optimising the relevant use. The TRAU makes a transcoding from the 64 kbit/s of the voice to 13 kbit/s Full Rate (or to 6.5 kbit/s Half Rate) enabling to address them with 16 kbit/s or 8 kbit/s flows.

The MSC block is in its turn connected to a switching centre of the terrestrial network PSTN (Public Switched Telephone Network) and/or ISDN (Integrated Services Digital Network). Two data bases called HLR and VLR, non visible in the figure, are generally located at the MSC; the first one containing the steady data of each Mobile Station MS and User Equipment UE, the second one containing the variable data; the two bases co-operate to enable the system to trace a user that widely moves on the territory, extended to different European countries. The BSCC station controller is also connected to a Personal Computer LMT (Local Maintenance Terminal) enabling the man/machine dialogue, to an Operation and Maintenance Centre OMC performing the supervision, management alarm, evaluation of traffic measurements, etc., functions called O&M functions (Operation & Maintenance), and finally to a SGSN block [Serving GPRS (General Packet Radio Service) Support Node] specified in GSM 04.64 for the packet switching data service.

Vertical dashed lines can be seen in the figure marking the limits of the interfaces among the main functional blocks, namely: the radio interface between MS or UE and BTSC is indicated with Uu, with A-bis similar that between BTSC and BSCC, with A-sub the interface between BSCC and TRAU, with A the interface between TRAU and MSC or directly between this last and BSC, with T the interface RS232 between BSCC and LMT, with O the interface between BSCC and OMC, and finally with Gb the interface between BSCC and SGSN and with Gs the interface between SGSN and MSC. The above mentioned interfaces are described in the following GSM recommendations: 04.01 (Um), 08.51 (A-bis), 08.01 (A), 12.20 and 12.21 (O), 04.60 (Gb).

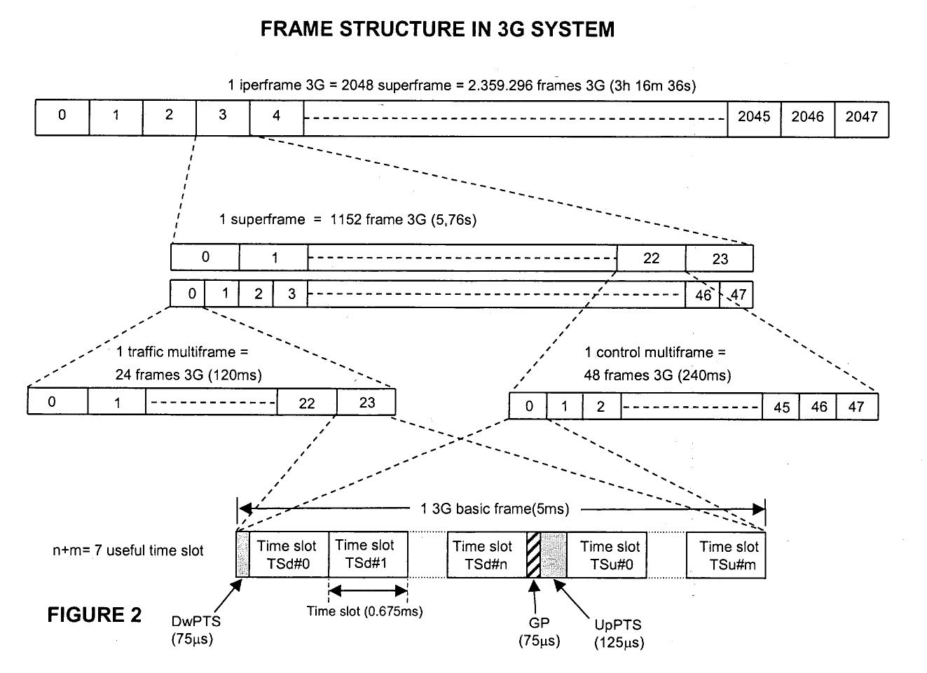

FIG. 2 shows basic frame and hierarchical multiframes used to describe a TDMA-CDMA-TDD mobile radio telephone system in which resides the invention in subject. With reference to the figure the sequential organisation of 7 time intervals, or time slots, is shown in addition to other three special time slots, which shall be described afterwards, within a 3G basic frame indefinitely repeated for the use of a generic carrier among those in use in a cell. The basic frame of FIG. 2 includes m uplink time slots TSu#0, . . . TSu#m coming from the mobile stations MS/UE and n downlink time slots TSd#0, . . . , TSd#n coming from BTSC station (FIG. 1). The set consisting of a carrier, a time slot of utilisation of the same and a spreading code forms a physical channel of the Uu interface destined to support an information characterising the channel from the logic point of view. The numbered sequential frames are embedded in a multilevel hierarchical structure unique in the 3G system. Whether the base stations BTSC transported reciprocally synchronised frames the handover procedures should be notably simplified and become shorter. Without setting limits to the present invention, it is convenient to make a general frame synchronization among all the cells of the different clusters, i.e. by exploiting GPS (Global Positioning System) satellite or other suitable methods; the resulting 3G system should be featured as TD-SCDMA-TDD (Time Division-Synchronous CDMA-TDD).

Going on in FIG. 2, starting in the figure from bottom to top, we see that the basic frame 3G includes n+m=7 useful time slots, each one having 0.675 ms duration, in addition to other three special time slots, which are in order: a DwPTS time slot (Downlink Pilot Time Slot) of the duration of 75 μs, a 75 μs guard time GP, and a UpPTS time slot (Uplink Pilot Time Slot) of 125 μs duration. The total duration of the basic frame is 5 ms. Number 24 3G basic frames form a 120 ms traffic multiframe. Number 48 3G basic frames form a 240 ms control multiframe. Number 24×48=1152 3G basic frames form a superframe of the duration of 5.76 s. The 1152 basic frames can come from either 48 traffic frames or 24 control frames. Number 2048 3G superframes form an iperframe consisting of 2,359,296 frames of the total duration of 3 h 16 m and 36 s. The shown hierarchy is not binding, for instance it is possible for signalling opportunity to consider two consecutive basic frames of FIG. 2 as two sub-frames of a new frame having double duration, belonging to a multiframe of 72 new frames having 720 ms total duration. This last opportunity is favourably considered in the invention.

In FIG. 3a a symmetric 3G basic frame is depicted. At the begin of the basic frame there is the special DwPTS time slot, followed by four downlink time slots, indicated in order TSd#0, 1, 2, 3, then by the guard time GP with the special DwPTS time slot, and finally by three uplink time slots TSu#0, 1, 2, 3 and by. The guard period GP, representing the switching point DL/UL, is used to avoid interference between uplink and downlink transmissions, as well as to absorb the propagation delays between the mobile stations MSs/UEs and the base station when the first ones send the first signal on the UpPTS channel; at this stage in fact the propagation delays are not yet known. The basic frame can be designed in not symmetric configuration to best support Internet traffic. In FIG. 3a both DwPTS and UpPTS time slots contain synchronization bursts not subject to spreading code, whose function shall be better detailed later on. The remaining time slots contain bursts having a same structure, subject to spreading code, and destined to traffic or signalling. In FIG. 3a the duration of the different useful time slots is expressed through a measurement unit called chip, whose duration is 0.78125 μs, equal to the reciprocal of a chiprate=1.28 Mcps corresponding to the common frequency of a set of N sequence codes used in a useful time slot to perform the spread spectrum according to the CDMA technique.

FIG. 3b shows that the uplink pilot time slot UpPTS includes a 128-chip SYNC1 sequence followed by a 32-chip guard period GP. FIG. 3c shows that the downlink pilot time slot DwPTS includes a 32-chip guard period GP followed by a 64-chip SYNC sequence. And FIG. 3d shows that the common structure of the remaining time slots includes two fields having equal length of 352 chips for data, placed respectively before and after a 144-chip midamble, with a 16 chip guard period GP at closing, for a total of 864 chips. Each one of the two fields given in FIG. 3d is modulated by a pre-set number of sequence codes to generate an equal number of radio channels in the band of the spread spectrum, which individually occupy the whole band and represent a same number of so-called resource units RU (Resource Unit) put at disposal of the service and of the signalling; the midamble on its side includes a training sequence used by the BTSC station and by the mobile stations MS/UE to evaluate the impulse responses of the number of radio channels generated, for the purposes mentioned later on.

With reference to data burst of FIG. 3d the following relation applies: Tₛ^{k}=Qₖ×T_{c}, where Qₖ is a spreading factor SF (Spreading Factor), freely selected among 1, 2, 4, 8, and 16, corresponding to said number N of code sequences; Tₛ is the duration of a transmitted symbol, and T_{c} is the fix duration of the chip. From the relation it can be noticed that increasing the spreading factor also the duration of symbols transmitted increases, in other words, the physical channel associated to the main burst increase, but the transmission speeds allowed on the same decrease. In APPENDIX APP1 two tables summarising the concepts described are given. TABLE 1-A1 shows the number of symbols that can be obtained from each data field of FIG. 3d's burst for the different spreading factor SF. TABLE 2-A1 shows the approximate data transmission speed for the different RU_{SF1 . . . 16}. From the information supplied we notice that employing a generalised spreading factor equal to 16 in the frame of FIG. 3a, each one of the 7 useful time slots will carry 54 symbols, to which 10 symbols for UpPTS, 6 symbols for DwPTS, 6 equivalent symbols for the GP period shall be summed up, totalling 400 symbols.

Before describing the use of the physical channel it is worth to complete the information featuring them from the radio point of view, starting from the radiofrequency spectrum. The frequency bands available for the 3G system can be allocated around 2 GHz and have variable widths according to the spectrum availability. More in particular, the area of availability is currently included between 1785 and 2220 MHz in non-contiguous bands with width ranging from 15 to 60 MHz, therefore it is possible make the 3G service coexist with that offered by other systems. TABLE 3-A1 of APPENDIX APP1 shows the main modulation parameters of the burst in FIG. 3d. The spreading sequences that modulate data (symbols) are sequences known as Walsh(n) functions. For an assigned spreading factor SF it is possible to select different Walsh functions SF, all orthogonal among them and with free assignment possibility to the mobile stations MS/UE in a same time slot. In the burst of FIG. 3d the 16 max possible users that share a time slot could be identified also at midamble level, which is not submitted to spreading code. To this purpose it proved to be useful to obtain (with known methods) a maximum of 16 different versions of the same midamble, cyclically phase shifting the code of a basic periodical sequence for multiples of a minimum shift width. The last significant operation left to consider is the scrambling, that is the multiplication of the elements of each sequence obtained from the spreading process by a scrambling sequence (mixing) typical of the cell. The scrambling confers a pseudo-noise characteristic to the sequence it is applied to. Spreading→scrambling operations can be compared to the application of a spreading code characteristic of the cell. The knowledge of the particular combination of spreading and scrambling codes assigned to the RU enables to transmit the signals to the radio interface Uu and to reconstruct the original signals submitting the signals received to descrambling and despreading inverse operations. Such an approach applies to the midambles.

FIG. 3e shows a possible configuration of the data burst of FIG. 3d in which two L1 Level 1 fields can be seen, placed immediately at the two sides of the midamble. Each one of the two L1 fields is also adjacent to an additional field, jointly destined to a signalling SACCH channel that shall be described afterwards. TABLE 4-A1 of APPENDIX APP1 shows the meaning, the position in the burst, and the dimensions of L1 fields in FIG. 3e. The indication of the third column means a spreading factor 16. The table includes three 2-bit fields called PC, SS, and SFL. The fields PC and SS include commands addressed to the transmitter to perform the Power Control (PC) and Synchronization Shift (SS) functions. The fields SFL is a Stealing Flag used in the same way as in the GSM. The first bit of the SFL symbol controls the pair bits of the burst of FIG. 3e, while the second bit controls odd bits. If the value of a control bit is set at “1”, the corresponding pair or odd bits of the burst shall transport signalling of higher Level (FACCH), otherwise the corresponding pair or odd bits of the burst shall transport data, as for instance for the voice. The SFL value is fix for the whole interleaving period along N frames, that depends on the service. The total of 6 bits of fields PC, SS, and SFL are equivalent to 96 chips (6 symbols). The remaining 304 chips for the Data field run out the burst capacity, therefore the four symbols for the SACCH channels must be included in the Data. TABLES 5-A1 and 6-A1 of APPENDIX APP1 show the mapping of the bits of PC and SS fields in the relevant commands, keeping in mind that the minimum step Pₛₜₑₚ is ±1 dB and 1/kT_{c} is ⅛ of the chip time T_{c}.

Two tables in APPENDIX APP2 show the sharing criterion of the following entities among the different cells of the 3G system: SYNC sequences of the burst DwPTS, scrambling codes, midambles, and SYNC1 sequences of the UpPTS burst (called also signatures). TABLE 1-A2 has 32 horizontal lines assigned to as many SYNC codes denoted DwPTS1, . . . , DwPTS32. In a 3G system the requirement of frequency separation between adjacent cells is not so determining as in the GSM it is, that because discrimination is done by means of isofrequential orthogonal code sequences. In the present case number 32 different scrambling code groups are foreseen, to be associated one to one with the 32 DwPTSn pilots. A singular scrambling code group consists of 4 different scrambling codes. The total of 128 scrambling codes are assigned to the DwPTSn pilots in the sequential numeric order as indicated in the table. Number 32 different midamble groups are foreseen, to be associated one to one with the scrambling code groups. A singular midamble group consists of 4 different basic midamble codes and each of the basic midamble code is linked to a respective unique scrambling code. The total of 128 basic midambles are assigned meeting the same numeric order of the scrambling codes. One only out of the 4 midambles of a group, is selected by the network when a dedicated channel is assigned, for the selected midamble the correspondent scrambling code is one to one. Maximum 16 versions of a selected midamble (obtained from 16 coded time-shifts) shall be supplied, as said above, when the need arises. In a cell the basic midamble codes and scrambling codes are the same for all carriers and time slots.

TABLE 2-A2 complete the preceding TABLE 1-A2 by introducing the sharing criterion of the signature sequences SYNC1 among the different DwPTSn pilots. Number 32 different Code Groups are foreseen. Each of 32 code groups includes in its turn the following elements:

one DwPTS SYNC sequence;

one UpPTS SYNC1 group of eight different SYNC1 sequences. The total of 256 sequences SYNC1 are assigned as indicated in the table. A mobile station MS/UE random selects one out of the eight sequences SYNC1 of the group associated to a pilot signal DwPTS to have access to the network through the cell identified by that specific pilot signal;

one scrambling code group of four different scrambling codes;

one basic midamble code group of four different midambles.

Inside a Code Group all the above indicated elements are each other associated to make a specific link. The 32 Code Group composition in TABLE 2-A2 is stored in the MS/UE and the relevant associations between the Code Groups and the cells constitute semipermanent data signalled from BCCH. The mobile, thanks to the stored information about code groups, knows the complete association since from the detection of the DwPTS SYNC sequence relevant to the selected cell. For example, if a base station uses the first SYNC sequence and a mobile station detects it during the cell selection procedure, then the same mobile station shall also use the first group of SYNC1 sequences, the first basic midamble code group, and the first scrambling code group. That avoids the mobile station a systematic listening of the BCCH channel for detecting the various group identifiers for SYNC1, midamble, and scrambling code in use in a selected cell before performing an access procedure. The cell selection procedure is sped up consequently. The various code lengths of the different elements in the two tables are: SYNC (64 bits), SYNC1 (128 bits), MIDAMBLE (128 bits), SCRAMBLING CODE (±16 bit numbers).

The number of 32 Code Groups and the relative composition ensures a good and future proof performance for the TD-SCDMA-TDD embodiment of the non-limiting example. In fact the choice of 32 SYNC sequences is a good compromise between the effort in the mobile station for detecting the correct SYNC sequence, rising with the number of the SYNC sequences, and the need to guarantee sufficient space apart for avoiding interference among isofrequential cells in adjacent clusters.

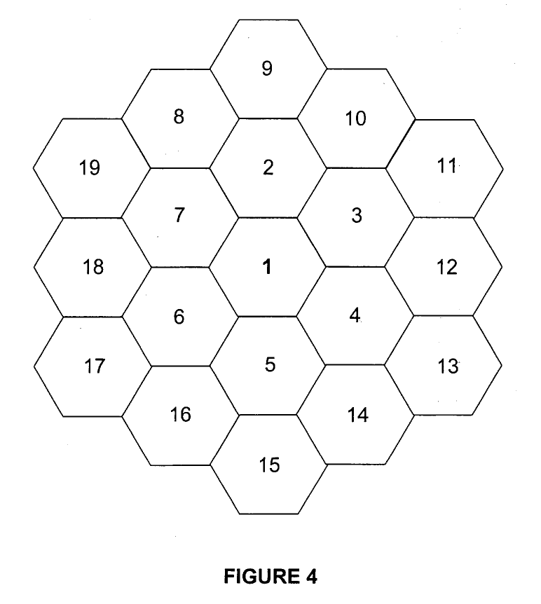

FIG. 4 shows a cluster of hexagonal cells belonging to a TD-SCDMA-TDD network. In the cluster 19 different SYNC sequences are needed to form two rings of cells around the regarded cell, number 1 in the case, without repeating the SYNC sequences in that cluster. For non-hexagonal networks it should be proved that a number greater than 22 and lower than 32 occurs, so the choice of 32 SYNC downlink sequences guarantees the presence of a second order ring in variously shaped clusters, shielding the inside cells from incoming isofrequential interferences and preventing to irradiate disturbances towards neighbouring clusters. Besides by using the indicated code groups the adjacent cells will have different groups of SINCY1 uplink sequences and the interference of the SINCY1 sequences intended for different base stations is avoided consequently. A number of 8 SYNC1 sequences for each code group constitutes a good compromise between maximum number of different sequences to be detected from the network, on the one hand, and the capacity of the random access and the handover on the other hand.

Furthermore, thanks to the before mentioned links, once a SYNC sequence is known four basic midamble codes only need to be tested in order to find the right midamble code and thus be able to synchronise the time slots of that cell and detect the various users. The choice of one out of four midamble in a cell and the one to one correspondence between midambles and scrambling codes, suggests the advantageous opportunity to perform midamble code hopping within the set of four midamble codes, that the same by hopping within the four scrambling codes.

The different time slots of the basic frame of FIG. 3a are, in a lesser or higher quantity, subject to beamforming by a resident intelligent antenna, of course in the sole BTSC. The time slots subject to beamforming are associated to a set of base band complex beamforming constants used in the spatial, or space-time filtering, made by BTSC on the transmission and reception time slots.

The entities introduced up to now, that is: band assigned to the system, frequency of carriers and their distribution among the different cells, structure of the basic frame and of the frame hierarchy, structure of pilot time slots DwPTS, UpPTS and of useful time slots, scrambling codes, midambles and relevant time shifts, number and spreading codes, beamforming constants, as well as other information that shall be described in short on the formation of physical and logic channels, etc., form the frameworks on which the 3G system is based, as conceived by the designers. This information generally characterises the Level 1 of the protocol and enter as a whole, or in part, the semipermanent data allocated to the different BSCC and BTSC posts dislocated all over the territory. The Mobile performing the roaming, or that is in idle state, is always subjected to the affiliation procedure that associates it to a “Location area” and in particular to a cell, of which it has to know the semipermanent data (frequency, DwPTS, basic Midamble group, Scrambling code group, UpPTS group). Appropriate system messages fulfil the purpose, which shall be then integrated with subsequent “ASSIGNMENT” messages, to assign the remaining elements (Midamble shift code, spreading factor and spreading code, beamforming constants, transmission power and time advance) that more properly configure the channel assigned in temporary mode to a connection that involves the radio interface Uu.

The DwPTS, UpPTS and Midamble elements, considering their importance in the 3G system, are better detailed here after. A pilot DwPTS is transmitted by a generic BTSC station without beamforming, or with sector beamforming, and enables the Mobile to perform a Cell Selection procedure when it switches from off to on. To this purpose, the Mobile, in its non volatile memory SIM (Subscriber Identity Module) has stored all the frequencies in use in the 3G system and the corresponding pilot DwPTS, in order that it can start a synchronization downlink scanning to determine the DwPTS pilot received with the highest power, so as to affiliate itself to the relevant cell and proceed to the reading of the broadcasting diffused system information. The Mobile shall thus know the basic midamble group in use in the cell and the relevant scrambling code group. The discrimination of the DwPTS pilot requires the use of a digital filter whose coefficients are programmed to be coupled to the SYNC sequence examined time by time. During the synchronization a tracing algorithm of the frequency that enables to remove the frequency offset from the signal received can be active. Other functions tasked to the downlink pilot DwPTS, which are only briefly outlined for brevity sake, are the On-air synchronization of adjacent base stations, and the indication to the Mobile units of the starting-position and of the interleaving period of a primary common control physical channel (CCPCH) from which to obtain broadcast diffused system information. This last function can be obtained with different techniques known to those skilled in the sector.

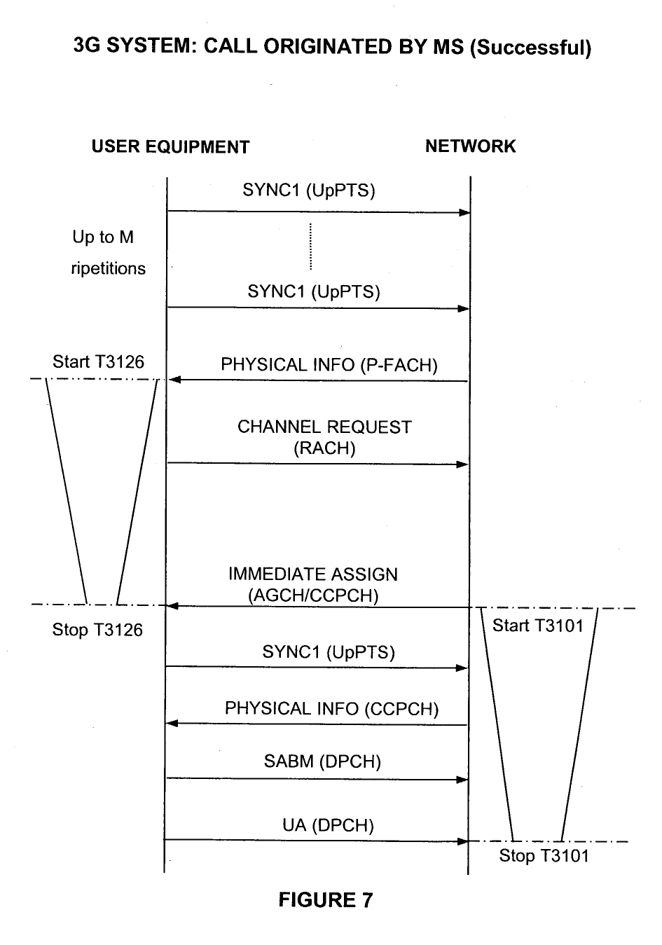

The UpPTS uplink pilots, on the contrary, are initially started by the mobile stations MS/UE in the Affiliation procedure (Location updating) that follows the Cell Selection phase. Successively they are transmitted during first and additional random accesses to the network respectively carried out in the following procedures: cell re-selection, either originating or terminating call, asynchronous handover. A mobile randomly selects one of the eight sequences SYNC1 to be sent uplink and starts sending it to begin one of those procedures in which is engaged. The eight gold sequences of a group are all orthogonal among them, so that they can be simultaneously transmitted by a same number of Mobile units and be discriminated by the base station BTSC without interfering. What said above, applies to all the 256 SYNC1 sequences. The UpPTS uplink pilots are very important in the TD-SCDMA-TDD mobile radio telephony system of the example because they allow the mobile stations MS/UE to gain synchronization in power and time before the identity of the mobile is known to the network, and before a dedicated channel be allocated to and the assigned midamble supplies this function. The correct dynamics of the originate call procedure shall be seen in the application example referred to FIG. 7.

A unique basic midamble can generate up to 16 different midambles in a cell, specified by as many coded shift-time values, as are the different versions of the burst that can contemporarily coexist in the time slot, thanks to the maximum Spreading Factor SF. Midambles are subject to the same beamforming and to the same transmission power of the data present in the bursts housing them. The code specifying a midamble is that of a training sequence for the evaluation of the impulse response of the associated radio channel. The functions connected to the midambles are:

Estimate of the radio channel. It is made both by the Mobile and by BTSC on signals received: since the BTSC station receives phase shifted versions of a same midamble in a time slot, it can profitably employ a joint estimate method, already known in the technique, through which the specific impulsive responses relevant to radio channels engaged by the different Mobile units are obtained in sequence at the output of the correlator, in a sole correlation cycle.

Measurements for Power Control: Measurements of the Signal/Interference power ratio are made both uplink and downlink to graduate the transmitted power. A mechanism is used based on an internal control loop, it is very fast since it is operated by the first sample of the impulse response, completed by a slower external loop based on quality measurements. Level 1 fields are foreseen in the main burst for the allocation of commands to the transmitters allowing the fast internal loop.

Holding of the uplink synchronisation. The BTSC station calculates the discrimination instant of the midamble compared to its own time basis, it compares this instant with the previous corrected value, the difference being the new TIMING ADVANCE value to be sent to the mobile for the correction of the initial transmission instant of the next burst. The accuracy in the uplink transmission is ⅛ of a chip duration. Level 1 fields are foreseen in the main burst for the allocation of commands to the transmitters enabling a quick control.

Correction of the frequency offset. It is a procedure made only by the Mobile units in downlink direction while acknowledging the midamble.

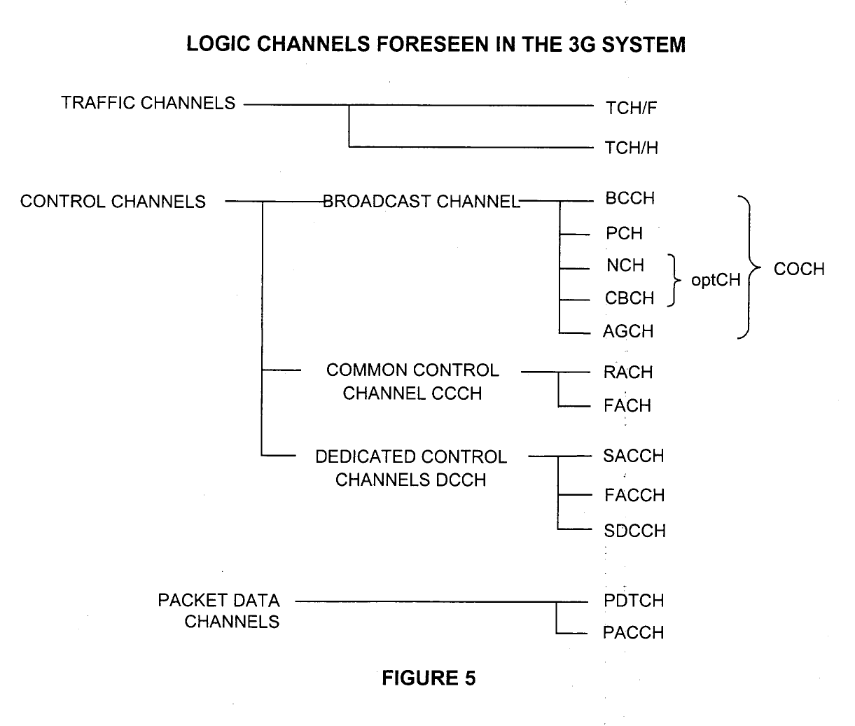

Making reference to TABLE 1-A3 of APPENDIX APP3 the physical channels corresponding to Level 1 elements described up to this moment, are now examined. The same table shows also the mapping of logic channels in the physical channels. Similar mapping information in graphic form is reproduced in FIG. 5. The physical channels highlighted in TABLE 1-A3 are: DPCH (Dedicated Physical CHannel), P-CCPCH (Primary-Common Control Physical CHannel), S-CCPCH (Secondary-Common Control Physical CHannel), P-RACH (Physical Random Access CHannel), P-FACH (Physical Forward Access CHannel), PDPCH (Packet Data Physical CHannel). Logic channels that can be mapped in the above mentioned physical channel are indicated in the Table with the following names: TCH (Traffic CHannel), SACCH (Slow Associated Control CHannel), FACCH (Fast Associated Control CHannel), BCCH (Broadcast Control CHannel), PCH (Paging Channel), AGCH (Access Grant CHannel), optCH (Optional CHannel), COCH (Common Omnidirectional Channel), RACH (Random Access Channel), FACH (single burst Forward Access Channel), PDTCH (Packet Data Traffic Channel), PACCH (Packet Associated Control Channel).

The primary channel P-CCPCH is, for instance, allocated in the downlink time slot TSd#0 adjacent to the pilot DwPTS. The channel P-CCPCH employs two. Resource Units having spreading factor 16. The channel has a fix radiation pattern that can be omnidirectional or subject to a limited beamforming to give the cell a given shape. The lowest shift value of the midamble is always associated to the channel. The primary channel P-CCPCH transports 23 information bytes of higher Level and supplies information on the other common control channels.

The secondary common channel S-CCPCH can be freely allocated in all the downlink time slots. The S-CCPCH channel employs two Resource Units having spreading factor 16 and can be subjected to an omnidirectional or adaptive variable beamforming.

The P-RACH random access channel can be allocated in one or more uplink time slots, whose number depends on the traffic foreseen, and is used to transport the messages of the Mobile units with the request of assignment of a service channel. The spreading factor is always 16 and can be subjected to an omnidirectional or adaptive variable beamforming. It partly contains Level 1 information.

The P-FACH forward access channel can be freely configured in all the downlink time slots. The spreading factor is always 16 and can be subjected to an omnidirectional or adaptive variable beamforming. It partly contains Level 1 information. The channel P-FACH carries the replies of the network to each sequence SYNC1 correctly revealed. The reply message is supplied on a single burst to limit the delay to one single 5 ms basic frame. The network, through the reply attached to the P-FACH channel, gives the mobile station that has sent the sequence SYNC1 an identifier of the acknowledged sequence and of the indications on the correct time advance and power level to be used in the transmission of the next message, that shall be very likely a request for a service message on the P-RACH channel.

The dedicated physical channel DPCH corresponds in FIG. 3e to the two fields L1 placed at the two ends of the midamble and at the adjacent fields reserved to SACCH channels. These are bi-directional channels subject to beamforming. The burst structure of FIG. 3e is not adequate to the use during the access to the network, characterised by an intensive use of PC and SS commands addressed to the different Mobile units, this task is performed by the physical channel P-FACH that employs the whole burst. The PDPCH packet data channel has the same structure of the DPCH dedicated channel, the meaning of Level 1 fields obviously changes.

Making still reference to APPENDIX APP3, the mapped logic channels shall now described. Logic channels are also called transport channels because used to deliver blocks supplied by the upper level protocol to the Physical level of the radio interface. From the functional point of view, logic channels of TABLE 1-A3 are grouped as indicated in FIG. 5. Making reference to the figure, we can notice the following three main groups: TRAFFIC CHANNELS, CONTROL CHANNELS, and PACKET DATA CHANNELS. The group of CONTROL CHANNELS includes the following channel types: BROADCAST CHANNEL, COMMON CONTROL CHANNEL, and DEDICATED CONTROL CHANNELS. The break down can be read in the table where TCH/F is a TCH Full-rate, TCH/H is a TCH Half-rate, and the optional channels are indicated with NCH (Notification CHannel), and CBCH (Cell Broadcast CHannel). As it can be noticed, all the channels referred to the BROADCAST CHANNEL are classified also as omnidirectional (COCH). The following description includes the functional aspect and the mapping methods and starts from the dedicated channels:

TCH (Traffic CHannels). These are bi-directional channels carrying the coded voice or data generated by the user in circuit switching mode. Two types are available: full-rate TCH/F and half-rate TCH/H. The whole payload is mapped in the physical channel DPCH in the portion not used for Level 1 signalling and SACCH channels. It is possible to map an RU_{SF8} or one, or two, RU_{SF16}. For high data rates, TCH channels can be combined. They are subject to beamforming.

FACCH (Fast Associated Control CHannel). It is associated to traffic channels TCH in bit stealing mode, as already said. It is mapped allocating 23 bytes in one or two interleaved frames. It is used by the network and the mobile stations MS/UE to transfer some urgent and important information, like that of the handover. This channel is also called main DCCH (Dedicated Control Channel) since it forms the skeleton of the so-called Main Signalling Link, that is a bi-directional Radio Link, unique for RR connection (Radio Resource) but that can temporarily be even double for the handover, made of at least one uplink RU and one downlink RU carrying a FACCH channel; SACCH is part of the Main Signalling Link and a TCH channel can also form part.

SACCH (Slow Associated Control CHannel). It is associated to the traffic channels TCH and is used by the network and Mobile units to transfer some non-urgent and non-critical information such as measurement data. It is mapped allocating 23 bytes in 24 successive 5-ms-frames and there are four symbols for the SACCH channel in each TCH burst, therefore the channels SACCH must be mapped within each TCH channel, differently from GSM.

BCCH (Broadcast Control CHannel). It diffuses downlink in broadcast mode the system information within a cell. The channel BCCH is mapped in two RU_{SF16} of the physical channel P-CCPCH. The channel BCCH shares the spaced frames of the physical channel together with the PCH channel or other common control channels. The sequence modulation of the pilot DwPTS indicates the starting of an interleaving period of the channel P-CCPCH containing the BCH channel (Broadcast Channel). The layout of the physical channel P-CCPCH is signalled in the system information. TABLE 2-A3 in APPENDIX APP3 gives an example of multiplexing of common control channels BCCH and PCH in the multiframe of 48 control frames. To this purpose, the multiframe is subdivided into spaced blocks, four basic frames long. A unique SYSTEM INFORMATION message is transmitted on a BCCH channel configurable at a pre-set position versus the System Frame Number SFN carried by BCCH itself.

PCH (Paging CHannel). It transmits downlink the paging messages to the Mobile units. It can have a radiation pattern either omnidirectional or subject to beamforming. Its mapping in P-CCPCH or S-CCPCH is indicated in the system information carried by BCCH.

AGCH (Access Grant CHannel). It is used downlink by the network to send a Mobile an answer to a previous Channel Request message sent by a Mobile on the P-RACH channel, whenever the message has been correctly revealed and accepted. Notice the difference from P-FACH that carries the answers to SYNC1.

CBCH (Cell Broadcast Channel). Is a channel used for the SMSCB service (Short Message Service Cell Broadcast).

NCH (Notification Channel). It is a channel used to notify the Mobile Units calls of the conference type.

RACH (Random Access CHannel). It is used by the Mobile units to transmit the request messages of a service channel. Its mapping in P-CCPCH is indicated in the system information carried by BCCH.

FACH (Forward Access CHannel). It is used by the network to transmit the Power Control (PC) and Synchronization Shift (SS) commands to the Mobile units as immediate reaction to the transmission of a SYNC1.

PDTCH (Packet Data Traffic CHannel). They carry packet switching data..

PACCH (Packet Associated Control CHannel). They carry signalling associated to packet switching data.

The control logic channels of the interface on-air Uu (FIG. 1), organized for instance as shown in FIG. 5, route the information in two propagation directions as messages exchanged between the Mobile and the network. This information passes over the frame of the Uu interface and concerns, more or less, the remaining parts of the network visible in FIG. 1. To enable a regular operation of the complex mobile system 3G it is necessary that messages be regulated both in the shape and in the flow through an appropriate protocol.

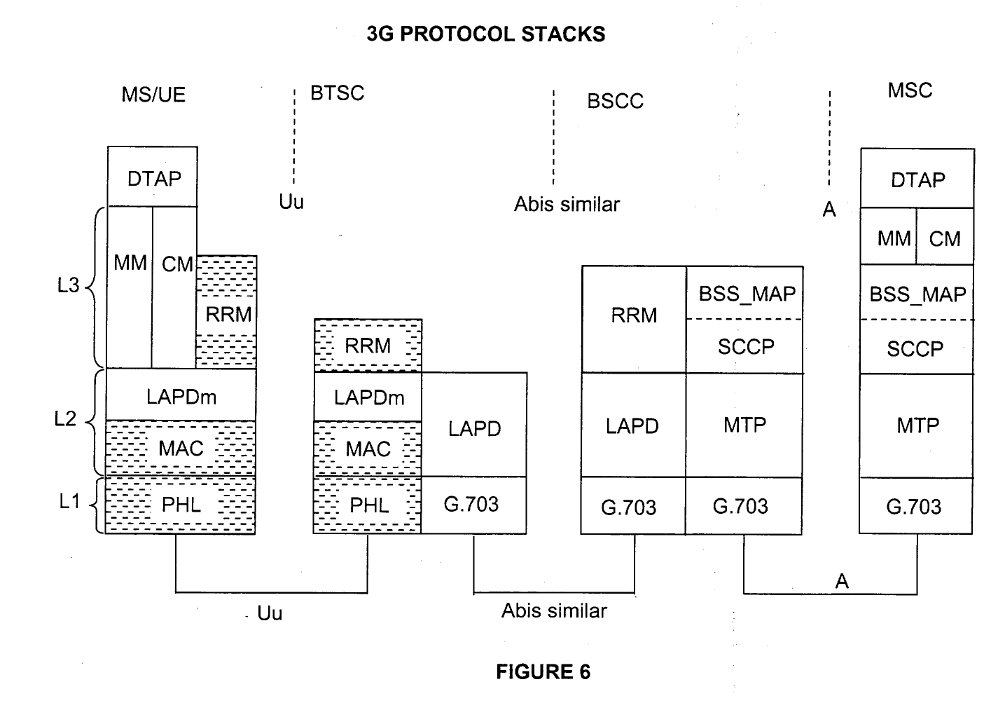

FIG. 6 shows the diagram of a protocol having several hierarchical levels used by the 3G system to manage the telephone signalling present at the different interfaces. For a great part, the protocol has been obtained from the one presently specified for GSM 900 MHz (Global System for Mobile communications) cellular system, adjusting it to the new requirements of the interface on-air Uu and to those deriving from data packet transmission. Some blocks (PHL, MAC, RRM) have been marked with a dashed line to indicate that the 3G system employs a suited version of the specified protocol. The level structure enables to subdivide the signalling protocol functions in groups of superimposed blocks on the control plane (C-Plane), and to describe the same as a succession of independent stages. Each level avails of the communication services provided by the lower level and offers its own services to the higher level. Level 1 of the above-mentioned protocol is strictly tied to the type of physical carrier used for the connection to the two sides of the different interfaces; it describes the functions necessary to transfer the bit flows on the radio connections to the interface Uu and on terrestrial connections to A-bis similar and A interfaces. Level 1 of terrestrial connections is described in recommendations CCITT G.703 and G.711. Level 2 develops functions controlling the correct sequential flow of messages (transport functions) in the aim of implementing a virtual carrier without errors between the connected points. Level 3 (called network level), and the higher levels, develop processing functions of the messages for the control of the main application processes. APPENDIX APP4 includes a LEGEND with the terminology used in FIG. 6 and two tables describing the function of the blocks in FIG. 6, respectively referred to level 2 (Table 1-A4) and level 3 (Table 2-A4).

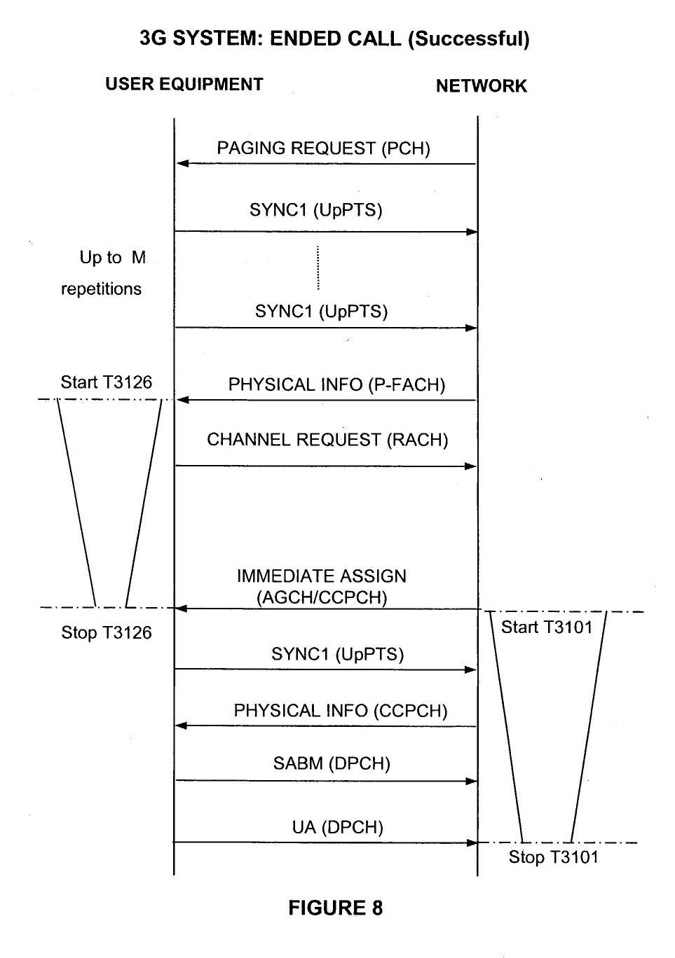

The main elements helping the operation of the 3G system of the non-limiting example have been introduced, then it is worth examining with reference to the FIGS. 7 and 8 the procedure of Originating Call and Terminating Call with the precise aim to detail the technical features of the present invention enforced in that procedure, or in similar two step procedures like for example: Asynchronous Handover and Uplink free. The charts of FIGS. 7 and 8 are so general to be valid also for the preceding TD-SCDM system of the citation. A synthetic view of these charts shows that the first SYNC1 signatures sent from the mobile receive a correlated reply from the network on a P-FACH channel; a successive CHANNEL REQUEST message sent from the mobile on a RACH channel receives a correlated reply from the network on a CCPCH channel; finally an assigned SYNC1 signature still sent from the mobile receive a correlated reply from the network on the same configured CCPCH channel.

At this point of the description it's useful to remind the following relevant technical problems to be solved:

a) The SYNC1 sequences assigned to a cell are orthogonal sequences so that different SYNC1 bursts can be simultaneously sent and still be discriminated at the receiver. Therefore, especially in highly loaded environments, the network may want to profit from the orthogonality property to increase the number of simultaneously acknowledged users by increasing the configured P-FACH; but here there will be the problem to inform the specific mobile stations from which P-FACH it has to be expected the relevant answers carrying the PHISICAL INFORMATION to get synchronization in power and time.

b) Generally more than one P-RACH has been configured in a cell, so a mobile station will be faced to the problem to know on which P-RACH physical channel it must send its Channel Request message.

c) As more than one P/S-CCPCH physical channel can be configured per cell, the accessing mobile station MS/UE will face the problem to know from which physical channel P/S-CCPCH it has to wait for the AGCH message granting the previous Channel Request message.

d) Finally the mobile station sends again an assigned SYNC1 signature for the second step time and power synchronization before entering the dedicated mode.

Before the invention that will be short-term described, a partial solution to the point b) was only provided in the following way:

1) After sending the SYNC1 signatures the mobile station starts listening the BCCH for the configured P-FACH channel which acknowledges its SYNC1 signature and carries the relevant PHISICAL INFORMATION;

2) when the configured P-FACH channel is known then also the P-RACH channel to which the mobile station has to send the CHANNEL REQUEST becomes known, either for direct signalling or for a beforehand association. The only aim was to avoid collision events on the common channel P-RACH;

3) when the CHANNEL REQUEST is sent the mobile station starts listening the BCCH for the configured P/S-CCPCH channel which carries the relevant AGCH message;

4) finally the mobile station sends again an assigned SYNC1 signature for the second step time and power synchronization before entering the dedicated mode.

The drawbacks of the above solution already mentioned in the introduction are overcome by the present invention in which the network initially estimates the number of P-FACHs, P-RACHs and the AGCH blocks per P/S-CCPCH channels according to its need, that is according to the traffic it is expected to serve, then configures the estimated channels by defining the following associations:

Which SYNC1 sequences, among the ones assigned to that cell, are associated to which P-FACHs: this association implies that any correctly detected SYNC1 sequence will be acknowledged by the network from a well defined P-FACH(s) only. The requirement should be that one SYNC1 sequence be associated to one P-FACH only, in order to avoid any ambiguity in the mobile station about where to look for the expected network answer. Vice-versa, more SYNC1 sequences per P-FACH can be configured because the configured P-FACH can acknowledge them separately, for example in successive TDMA sub-frames.

Which P-RACHs, among the configured ones, are associated to which P-FACHs channels: this implies that a mobile station receiving the network acknowledgement to a previously sent SYNC1 sequence from a specific P-FACH, will forward its Channel Request message on one of the associated P-RACHs only. The requirement should be to associate a P-RACH to one P-FACH only in order to reduce collision on the P-RACH, which may happen in case more P-FACHs correspond to the same P-RACH. Vice-versa, more P-RACHs per one P-FACH can be configured, however this configuration makes more difficult and less precise to signal to the mobile station the proper power level setting for accessing to the associated P-RACHs, as it is unknown to the network which one will be chosen by the mobile station. Note that according to the suggested method collisions on the P-RACH can be limited, as one P-FACH can bring the acknowledgement to one SYNC1 burst only at a time, this implies that one mobile station only will access the associated P-RACH at a time, unless of possible wrong message detection from the air interface.

Which P-RACHs, among the configured ones, are associated to which P/S-CCPCHs carrying the AGCH blocks. This implies that a mobile station having sent a Channel Request message on a specific P-RACH, will wait for the relevant network answer to its request from the associated Primary or Secondary CCPCHs only. Here the requirement should be that one P/S-CCPCH only be associated to one P-RACH, in order to avoid any ambiguity in the mobile station about where to look for the expected answer from the network.

As stated in the introduction, the above relation between the SYNC1 bursts and the affected common physical channels can be represented as follows:

SYNC1→P-FACH→P-RACH→P/S-CCPCH

where the arrow indicates one to one association.

The network will broadcast through the BCCH channel at the air interface Uu the implemented configurations, so that to inform the mobile stations aiming to access to the system services. TABLE 3-A3 of APPENDIX APP3 shows a transport channel mapping referred to a 5 ms sub-frame suitable to carry out the complete associative link of above. With reference to TABLE 3-A3 the BCH is mapped on at least one Resource Unit (RU) in the first downlink time slot TSd#0 following DwPTS pilot. In order to provide the coverage of the whole cell the time slot TSd#0 with BCH has to have higher transmission power level 9-11dB higher than average power level in one RU with omni-directional or sectorial pattern (without beamforming) compared with the regular time slot which is beamformed. The RU allocated for BCH will be shared with other common control channels PCH and other optional FACH channels according, if necessary, to the multiframe structure shown in TABLE 2-A3 of the same APPENDIX APP3. The PCH is a special broadcast channel used to paging MS/UEs from base station side; it is also mapped onto the same downlink time slot TSd#0 as BCH. Consequently the PCH channel is always transmitted with the same power level and antenna pattern as those of the BCH. Four RUs are intentionally located in downlink time slot TSd#1 destined to as many FACH channels. Four RUs are located in the first uplink time slot TSu#0 following UpPTS pilot to be destined to as many RACH channels.

With reference to the FIGS. 7 and 8 are now examined in detail both the procedure of Originating Call from the mobile station MS/UE (Mobile) and the procedure of Terminating Call towards Mobile. In the message sequence charts of the FIGS. 7 and 8 all the entities (BTSC, BSCC; MSC) different from the mobile station MS/UE (Mobile) are indicated with the generic term “network”, maintaining the possibility to specify the physical or protocol entity involved. The procedures of the two figures are similar each other and both originate from an Idle state of the Mobile in which it monitors the Paging messages sent by the network on PCH channels. Entering in the first one rather that in the second one depends on the fact that the Mobile decides on self-initiative to request a channel rather than being ordered to do it by the network. The phases coming after entering one or the other operation phase belong to an IMMEDIATE ASSIGNMENT procedure, whose purpose is that to establish a RR connection (Radio Resource) between the Mobile and the network. From this point on, the description applies to both the figures, assuming that before, starting the IMMEDIATE ASSIGNMENT procedure, the Mobile has acquired the following information from the so-called System Information contained in the P/S-CCPCH (BCCH) channel:

the map between the SYNC1 signatures and P-FACH channels; between the channels P-FACH and P-RACH channels; between the P-RACH channels and AGCH channels configured in P/S-CCPCH as stated by the present invention;

the uplink interference level on the uplink pilot UpPTS;

the level of transmission power of the P-CCPCH channel;

the System Frame Number SFN;

the following control parameters of the random access:

1. the step PSTEP to increase the power level at each retransmission of SYNC1;

2. the maximum value “M” for the retransmission of the SYNC1 burst;

3. the number of frames “Tx-integer” between retransmission of the two SYNC1 bursts;

4. the values of control access parameters “CELL_BAR_ACCESS”;

5. the allowed access classes “AC” and “EC”.

This said, the IMMEDIATE ASSIGNMENT procedure can be started only by the RR (Radio Resources) entity of the Mobile. The initialisation is triggered by a request of sublevel MM (Mobility Management) or by the LLC level (Low Layer Compatibility) to enter the dedicated mode, or by the RR entity in reply to a PAGING REQUEST message. At such a request: if the access to the network is allowed, the RR entity of the Mobile starts the immediate assignment procedure that shall be defined, otherwise it rejects the request. The request from sublevel MM to establish a RR connection specifies an “establishment cause”. Likewise, the request from the RR entity to establish a RR connection in reply to a PAGING REQUEST 1, 2 or 3 message, specifies one the causes of establishment “answer to paging”.

All the mobile stations MS/UE with a SIM card inserted are members of one of the 10 access classes numbered 0 to 9. The access class is stored in the SIM. In addition, the Mobile Units stations can be members of one of the 5 access special classes (11 to 15) also stored in the SIM card. The System Information messages on the BCCH channel broadcast the list of the access authorised classes, of special ones, and if emergency calls are allowed in the cell to all the Mobile units or only to the members of authorised special access classes. If the “establishment cause” for the request of a sublevel MM is not an “emergency call”, access to the network is granted only if the Mobile is member of at least one authorised access class, or of an authorised access special class. On the contrary, in case the “establishment cause” is an emergency call, the access to the network is allowed if and only if emergency calls are allowed to all the Mobile units of the cell, or if the Mobile is member of at least an authorised special access class.

The previous points 3 to 6 relevant to parameters “M” and “Tx-integer”, together with what said on the access classes, represent the mechanisms implemented in the GSM to limit the collisions on the RACH channel. They essentially consist in expanding in time the repetition of the random access attempts made by a mobile, limiting the same in number in order not to overload the channel. When this mechanism proves to be insufficient, like for instance in peak traffic moments, the mechanism of the access classes that selectively and temporarily inhibits the access to the network to groups of users comes into play. Once the access requirements are met, the RRM (Radio Resource Management) protocol of the Mobile starts the IMMEDIATE ASSIGNMENT procedure scheduling in an appropriate way the transmission of a SYNC1 burst on the physical channel UpPTS, consequently leaving the idle mode (in particular ignoring paging messages). The Mobile shall then send M+1 burst SYNC1 on the UpPTS channel in order that the number of frames between the starting of the immediate assignment procedure and the transmission of the first burst SYNC1 (excluding the frame containing the burst itself) is a number randomly showing for each new starting of the immediate assignment procedure with even distribution probability in set {0, 1, . . . , Tx-integer(N−1)}.

After having sent the first burst SYNC1 the Mobile starts monitoring the corresponding P-FACH channel, linked as indicated by the present invention, to reveal the PHYSICAL INFORMATION message. This message shall contain the reference number of the signature used by MS; the number of the control frame CFN; the relevant number of frames of the acknowledgement message from the one carrying the acknowledged burst SYNC1; the interference Level on the corresponding P-RACH channel, linked as indicated by the present invention; the Timing advance and the Power level correlated to the acknowledged burst SYNC1. The PHYSICAL INFORMATION message is waited for within 4 frames from SYNC1 transmission. In case no valid reply is revealed, the above mentioned procedure must be repeated up to M times or up to revealing of the message waited for by the network.

Having sent M+1 SYNC1 bursts with no valid answer from the network, the immediate assignment procedure is aborted; if said procedure was triggered by a request of the MM sublevel, these are notified of the failure of the random access. The Mobile, as soon as the waited message is revealed, starts a timer T3126 and sends a CHANNEL REQUEST message on the corresponding P-RACH channel, linked as indicated by the present invention, with the correct values of synchronization and power level parameters. The CHANNEL REQUEST message shall contain at least the following parameters:

An “establishment cause” corresponding to the “establishment cause” given by the sublevel MM, or corresponding to a cause “reply to paging” data given by the RR entity in reply to the PAGING REQUEST message including the information on the channel needs;

A random reference randomly selected from an even distribution probability for any new transmission;

the Time Advance and the Power Level employed by the Mobile to have access to the network;

The interference level on that Time slot signalled in broadcast by the network.

The Mobile, after transmission of the CHANNEL REQUEST message, starts monitoring the corresponding P/S-CCPCH, linked as indicated by the present invention, to detect the IMMEDIATE ASSIGNMENT message waiting for it on the AGCH configured channel. When the count of timer T3126 expires, the procedure of immediate assignment is aborted and the sublevel MM is-notified of the failures of the random access, in the case MM were responsible for the actuation of the access procedure.

The network can allocate a channel “dedicated” to the Mobile sending it an IMMEDIATE ASSIGNMENT message in no-acknowledgement mode on the AGCH configured channel. A Timer T3101 is then started on the network side. The IMMEDIATE ASSIGNMENT message shall contain: the description of the assigned radio RU resource, the channelling code, the frequency and the Time slot; the information field of the CHANNEL REQUEST message and the frame number of the frame in which the above-mentioned message has been received; the starting timing advance and the power level the MS shall use for the next transmission on the dedicated channel; and the signature reference number SYNC1 for the second step access; optionally, the indication of a starting time indicated by the frame number.

The Mobile, on receipt of an IMMEDIATE ASSIGNMENT message corresponding to its CHANNEL REQUEST message, stops the Timer T3126 and at the next frame versus the scheduled one sends a SYNC1 burst assigned by the network on the physical channel UpPTS.

The network replies to the burst SYNC1 at the frame immediately after, sending a PHYSICAL INFORMATION message enabling an additional finishing of the synchronisation and of the power level Mobile side. At the same time the Mobile shall switch on the channel assigned in reception mode, setting the channel mode for the sole signalling; the transmission mode shall be enabled the frame after the burst SYNC1 has been heard, even in the case an invalid PHYSICAL INFORMATION message has been received by the network. The Mobile establishes then the main signalling link on a dedicated channel DPCH with a SABM (Set Asynchronous Balanced Mode) containing an information field. In case the Mobile receives an IMMEDIATE ASSIGNMENT message containing only the description of a channel to be used after the starting time, it shall wait until the starting time before having access to the channel. If the starting time has already elapsed, the Mobile will have access to the network as immediate reaction to the message reception. In this case, it is recommended that the Mobile sends the burst SYNC1 just in time before switching the assigned channel, in order that its synchronism and the power level are updated as much as possible.

If no channel is available for the assignment, the network sends the Mobile an IMMEDIATE ASSIGNMENT REJECT message in unacknowledged mode on the corresponding P/S-CCPCH channel. This message contains the reference to the request and a wait condition. The Mobile, on reception of an IMMEDIATE ASSIGNMENT REJECT message corresponding to its CHANNEL REQUEST message, shall start a Timer T3122 (not shown in the Figures) with the value indicated of IE (Information Element “Wait Indication” referred to the cell in which it has been received), and shall monitor on the corresponding P/S-CCPCH channel until the count of timer T3126 expires. During this time, additional IMMEDIATE ASSIGNMENT REJECT messages are ignored, but any immediate assignment corresponding to its CHANNEL REQUEST message, makes the mobile perform the procedure described in the following steps. If no IMMEDIATE ASSIGNMENT message is received, the Mobile returns in idle mode CCCH to monitor its paging channels. As an option the Mobile can return in idle mode CCCH as soon as it has received an answer from the network to its CHANNEL REQUEST message. The Mobile is not permitted to make a new attempt in the same cell to establish a RR connection without emergency until the count of the Timer T3122 expires. The Mobile, provided that an IMMEDIATE ASSIGNMENT REJECT is not received for an emergency RR connection attempt, can try to enter in dedicated mode for an emergency call the same cell before the count of the Timer T3122 is expired. The Mobile in “packet idle mode” (limited to the Mobile units supporting the GPRS) can start a packet access in the same cell before the count of the Timer T3122 is expired. After expiration of T3122, no CHANNEL REQUEST message shall be sent as reply to a page, up to reception of a PAGING REQUEST message for the Mobile.

The IMMEDIATE ASSIGNMENT procedure is ended on the network side when the main signalling link is established. The Mobile sends the UPLINK ACCESS message (UA), the network stops the Timer T3101 and the sublevel MM of the network side is informed that the RR entity entered the dedicated mode.

The procedures of FIGS. 7 and 8 have been well detailed for the sake of completeness of the description, now it's useful to summarise the main steps of the subject matter of the present invention to make it more immediate. Both the Originating and Terminating Call procedures of FIGS. 7 and 8 are substantially based on a so-called Random Access procedure subjected to the invention, that is true also for asynchronous handover and uplink free procedures.

The Random Access procedure according to the present invention includes two parts: a preliminary one charged only to the network (BSSC), and an actual part in which the mobile stations MS/UE and the network are exchanging reciprocal protocol messages to allow the mobile stations gain the network services. Before entering the preliminary part the number and configuration of relevant common channels are supposed to be estimated according to the traffic the serving cell is expected to serve through them and the relevant information is included into semipermanent data stored in the base station BTSC of the serving cell and broadcasted on common BCCH channel. In particular the following channels take relevance:

P-FACH physical forward access channels, usable by the network for carrying downlink the so-called physical information for time and power synchronization of the mobile stations;

P-RACH random access channels, usable by the mobile stations for delivering to the network the channel request messages originated from the mobile stations;

P/S-CCPCH primary/secondary physical channels, usable by the network for carrying downlink the access grant logical channels AGCH containing the configuration parameters of dedicated service channels together with the network answer to any correctly detected and accepted channel request message. and

The preliminary part of the random access procedure is charged to the definition, the storing into semipermanent data of the serving cell, and the broadcasting on common BCCH channel of the possible associative links:

SYNC1→P-FACH→P-RACH→P/S-CCPCH

defined with the already mentioned criteria.

Mobiles in idle state are always listening the BCCH channel diffused by the network so as the paging PCH channels, the number and configuration parameters of all the involved channels and their associative links. A mobile station MS/UE which enters the actual part of the random access procedure, either by its initiative or stimulated from the network, executes the following sequential steps:

1) randomly chooses a SYNC1 signature burst among those supported by the cell and send it to the base station BTSC on the uplink pilot time slot UpPTS;

2) turns out to listen the associated P-FACH physical channel for detecting the relevant physical information suitable to adjust time synchronism and power level for the successive uplink transmission, that because the initial selection of the SYNC1 burst corresponds as well to the selection of a specific P-FACH physical channel;

3) receives the relevant physical information and exploits it for adjusting- time synchronism and power level before delivering its channel request message on the associated P-RACH physical channel to be transmitted uplink, that because the initial selection of a SYNC1 burst corresponds as well to both the selection of a specific P-FACH and P-RACH physical channels;

4) turns out to listen to the associated P/S-CCPCH physical channel for getting the AGCH logical channel indicating a dedicated service channel granted from the network to the requested channel, that because the initial selection of a SYNC1 burst corresponds as well to the selection of a specific P-FACH and P-RACH and P/S-CCPCH physical channel.

The remaining part of the random access procedure, namely the second step in which an assigned signature burst SYNC1 is sent to refine timing and power synchronization before the mobile station enters the dedicated channel, should be considered as known.

The network in its turn which enters the actual part of the random access procedure, either by paging messages or prompted from a mobile station, executes the following sequential steps:

a) detects all the orthogonal SYNC1 signature bursts received among those supported by the cell, and for each detected SYNC1 signature measures the relative time delay and the power level for making up as many backward acknowledgement messages each including a correlative field to the detected SYNC1 signature and physical information to correct timing and power level of the correspondent transmitter;

b) inserts the acknowledgement messages into the P-FACH physical channels, or channel, to which the correlated SYNC1 signature bursts are associated to be transmitted downlink;

c) turns out to listen all the configured P-RACH physical channels in order to detect all the channel requests originated from the mobile stations which have received their acknowledgements from the respective P-FACH physical channels associated to the listened P-RACH physical channels;

d) processes each channel request in order to generate, whenever accepted, as many assignment messages including the configuration parameters of respective dedicated channels carrying the services supplied from the network;

e) inserts the assignment messages into as many P/S-CCPCH physical channels associated to the P-RACH physical channels to which the channel requests have been detected to be transmitted downlink.

The remaining part of the random access procedure, namely the second step detection of all the assigned signature bursts SYNC1 to refine timing and power synchronization before the mobile stations enter the dedicated channels, should be considered as known.

The overall sequential steps belonging to the random access procedure concurrently executed by the mobile stations and the network are obviously interleaved and each other synchronized by the intercepted relevant events so as to respect the following sequential order: 1)→ 2)→ a)→ b)→ c)→ 3)→ 4).→ d)→ e).

### Extensions on Physical Channel Associative Links

The present invention is susceptible of some extensions beyond the non-limiting embodiment described up to now. In particular being the focus of the invention centred on a full association linking all the relevant channels entering the random access procedure, it comes up consequently the possibility to exploit the teaching of the invention also in cellular systems built in conformance to different techniques other than TD-SCDMA-TDD of the non-limiting example. In particular the invention can be used in the other following systems:

wide band CDMA cellular networks;

CDMA cellular networks with full-duplex FDD (Frequency Division Duplexing);

TDMA-CDMA-FDD cellular networks;

TDMA-CDMA-TDD cellular networks.

The CDMA systems, as known, have undergone stringent equalisation requirements in timing and power level which have to be met before entering a dedicated channel, that is during the random access procedure. For these purposes they make use of opportune pilot channels carrying gold code sequences both downlink and uplink. The mechanics of the random access procedures can be slightly different from the various systems but the main steps are the same. These steps are always charged to the following tasks: cell selection and downlink synchronisation, uplink synchronization and channel requesting, finally granting of a dedicated channel. Different signalling channels are involved inevitably and their configuration parameters have to be made known in the serving cell, that is true anyway in the system. Consequently the physical channel associative links disclosed in the present invention are in any case applicable in the above indicated CDMA systems. Nevertheless TDMA-CDMA systems best deploy signalling channels, because they can additionally exploit the frame and multiframe structure other than the usual spreading codes. Furthermore the full-duplex TDD (Time Division Duplexing) technique allows a still better exploitation of the available spectrum resources and the intrinsic aptitude to manage asymmetric traffic, typical in Internet applications. The TD-SCDMA-TDD of the non-limiting example maintains the advantages of the TDMA-CDMA-TDD and further introduces the benefit derived from the synchronisation, such as that to simplify and shorten the handover procedure.

[image]

[image]

[image]

[image]

[image]

[image]

[image]

[image]

1. A random access procedure in a cellular telephony system based on the so-called CDMA technique by which individual coding sequences each other orthogonal are respectively assigned to both a base station (BTSC) and the served mobile stations (MS, UE) for spread-spectrum modulating an uplink carrier and de-spreading demodulating a downlink carrier, in order to support a variety of service physical control channels for providing synchronisation, signalling and services and conseguently enabling a reliable two-way communication,
said physical control channels including:
synchronisation channels constituted by signature bursts (SYNC1) valid into the serving cell, randomly selected by the mobile stations and transmitted for gain uplink synchronisation and power adjustment;
forward access channels (P-FACH, FACH) carrying towards the mobile stations the so-called physical information suitable to adjust timing and power level of the transmitters;
random access common channels (P-RACH, RACH) acceded by the mobile stations intending to send their channel requests to the network;
access grant channels (P/S-CCPCH, AGCH) containing the configuration parameters of dedicated service channels (DPCH) together with the network answers to any correctly detected and accepted channel request message;
broadcast channels (P/S-CCPCH, BCCH) for diffusing the system information (BCCH) inside the serving cell about number and configuration parameters of the said provided physical control channels estimated according to the traffic expected to serve through them by the serving cell,
characterized in that it includes:
a preliminary step adapted to establishing associations between the configuration parameters of said physical control channels, and
actual steps adapted to exchange protocol messages with the network (BSSC, MSC),
said associations carried out in the course of said preliminary step including:
one signature burst (SYNC1) being associated to one forward access channel (P-FACH) only, repeating the association for all the uplink synchronisation channels, in order to avoid any ambiguity in the mobile stations about where to look for the expected acknowledgement from the network;
one random access common channel (P-RACH) being associated to one forward access channel (P-FACH) only, repeating the association for all random access common channels, in order to reduce collision on the latter (P-RACH);
one access grant channel (P/S-CCPCH, AGCH) only being associated to one random access common channel (P-RACH), repeating the association for all the access grant channels (P/S-CCPCH, AGCH), in order to avoid any ambiguity in the mobile stations about where to look for the expected answer from the network with the indication of the dedicated service channels (DPCH); and
said actual steps including:
broadcasting into the serving cell to be read by the mobile stations (MS, UE) each complete associative link binding the involved physical channels;
exchanging protocol messages with the network (BSSC, MSC) through said associative links in order to signalling at once to the mobile stations the route towards the services offered by the network, simplifying the access procedure consequently.

2. A random access procedure according to claim 1, characterized in that the CDMA system further exploits the so-called TDMA technique by which the carrier is assigned in turn to the Mobile Stations (MS, UE) which complete the spread-spectrum modulation, and the opposite operation, into a fixed duration of a time slot inserted in a basic sub-frame indefinitely repeated into frames and multiframes having embedded the said physical channels (P-FACH, P-RACH, P/S-CCPCH), said signature bursts (SYNC1) and said configuration parameters including: frequency, spreading code, time slot number, and the interleaving period in the multiframe from an assigned starting point.

3. A random access procedure according to claim 2, characterized in that said uplink carrier and said downlink carrier coincide and the TDMA-CDMA system further employs a so-called TDD technique to carry out a Time Division Duplexing enabling two-way communication.

4. A random access procedure according to one of the preceding claims, characterized in that:
the signature bursts (SYNC1) and the configured forward access channel (P-FACH) are associated one to one;
the configured random access common channel (P-RACH) and the configured forward access channel (P-FACH) are associated one to one;
the configured access grant channels (P/S-CCPCH, AGCH) and the configured random access common channel (P-RACH) are associated one to one.

5. A random access procedure according to any claims from 1 to 3, characterized in that more signature bursts (SYNC1) are associated to said one configured forward access channel (P-FACH), and said one configured forward access channel (P-FACH) acknowledges the associated signature bursts (SYNC1) separately in successive TDMA sub-frames.

6. A random access procedure according to one of the preceding claims, characterized in that a mobile station (MS, UE) which enters the actual part of the random access procedure, either by its initiative or stimulated from the network (BSSC, MSC), executes the following sequential steps:
1) randomly chooses a signature burst (SYNC1) among those supported by the cell and send it to the base station (BTSC);
2) turns out to listen the associated forward access channel (P-FACH) for detecting the relevant physical information suitable to adjust time synchronism and power level for the successive uplink transmission;
3) detects the relevant physical information and exploits it for adjusting time synchronism and power level before transmitting its channel request message through the associated random access common channel (P-RACH);
4) turns out to listen to the associated access grant channel (P/S-CCPCH) to get indication of said dedicated service channel granted from the network to the requested channel.

7. A random access procedure according to any claims from 1 to 5, characterized in that the network which enters the actual part of the random access procedure, either by paging messages or prompted from a mobile station (MS, UE), executes the following sequential steps:
1) detects all the received orthogonal signature bursts (SYNC1) among those supported by the cell, and for each detected signature burst (SYNC1) measures the relative time delay and the power level for making up as many backward acknowledgement messages each including a correlative field to the detected signature burst (SYNC1) together with the physical information to correct timing and power level of the correspondent transmitter;
2) inserts the acknowledgement messages into the forward access channels (P-FACH) to which the correlated signature bursts (SYNC1) are associated to be transmitted downlink;
3) turns out to listen all the configured random access common channel (P-RACH) in order to detect all the channel requests originated from the mobile stations;
4) processes each channel request in order to generate as many assignment messages including, whenever accepted, the configuration parameters of respective dedicated channels carrying the services supplied from the network;
5) inserts the assignment messages into as many associated access grant channels (P/S-CCPCH, AGCH) to be transmitted downlink.

8. A random access procedure according to one of the preceding claims, characterized in that the overall sequential steps belonging to the actual part of the random access procedure concurrently executed by the mobile stations (MS, UE) and the network (BSSC, MSC) are interleaved as in the following sequential steps:
1) a mobile station randomly chooses a signature burst (SYNC1) among those supported by the cell and send it to the base station (BTSC), then turns out to listen the associated forward access channel (P-FACH) for detecting the relevant physical information suitable to adjust time synchronism and power level for the successive uplink transmission;
2) the network detects all the received orthogonal signature bursts (SYNC1) among those supported by the cell, and for each detected signature burst (SYNC1) measures the relative time delay and the power level for making up as many backward acknowledgement messages each including a correlative field to the detected signature burst (SYNC1) together with the physical information to correct timing and power level of the correspondent transmitter;
3) the network inserts the acknowledgement messages into the forward access channels (P-FACH) to which the correlated signature bursts (SYNC1) are associated to be transmitted downlink, then turns out to listen all the configured random access common channel (P-RACH) in order to detect all the channel requests originated from the mobile stations;
4) the mobile station detects the relevant physical information and exploits it for adjusting time synchronism and power level before transmitting its channel request message through the associated random access common channel (P-RACH), then turns out to listen to the associated access grant channel (P/S-CCPCH) to get indication of said dedicated service channel granted from the network to the requested channel;
5) the network processes each channel request in order to generate, whenever accepted, as many assignment messages including the configuration parameters of respective dedicated channels carrying the services supplied from the network and inserts the assignment messages into as many associated access grant channels (P/S-CCPCH, AGCH) to be transmitted downlink;
6) the mobile station detects the assignment message to the associated access grant channel (P/S-CCPCH) and complete the procedure entering the dedicated channel.

9. A random access procedure according to one of the preceding claims, characterized in that a suitable number of cell-discriminating code groups is provided in the cellular telephony system equal to, or greater than, the maximum number of cells belonging to a non-hexagonal cluster, and each cell-discriminating code group includes:
said signatures (SYNC1) only valid into the serving cells used for uplink synchronisation and first accesses;
a downlink synchronization burst (DwPTS) unambiguously assigned to the cells for enabling the mobile stations (MS, UE) to identify the serving cell and revealing the position of said broadcast channels (P/S-CCPCH, BCCH) diffusing the system information, and further to synchronise base stations (BTSC) among themselves if the case needs it;
a group of unique basic sequences, also termed basic midambles, unambiguously assigned to the cells to be embedded into the transmitted data bursts in order to continue the timing synchronization and power control at the end of the random access procedure, and further to estimate the pulse response of the relative channel for correctly detect the transmitted signal; being one only out of all the basic midambles of the group selected by the network when a dedicated channel is assigned;
a group of scrambling codes unambiguously assigned to the cells, each scrambling code being one to one with the basic midambles, for multiplying the elements of each sequence obtained from the spreading process so as to conferring a pseudo-noise characteristic typical of the cell; information being broadcasted on the BCCH channels about the composition of all the cell-discriminating code groups provided in the cellular system for simplifying to the mobile stations the execution of cell selection procedure.

10. A random access procedure according to claim 9, characterized in that a basic midamble code hopping is performed.

11. A random access procedure according to claim 9 or 10, characterized in that as many different versions of the same midamble as the number of spreading code sequences are obtained by cyclically phase shifting the code of said basic midamble for multiples of a minimum shift width.

12. A random access procedure according to claim 11, characterized in that: the number of said cell-discriminating code groups is 32 inside which: the number of signatures (SYNC1) is 8, the number of basic midambles is 4, the number of scrambling codes is 4, the maximum number of spreading code is 16 so as the versions of the basic midamble.

13. A random access procedure according to any claim from 3 to 12, characterized in that: said sub-frame is comprised of the following bursts listed in their time sequential order:
said downlink synchronization burst (DwPTS);
a convenient number n of downlink data bursts (TSd#0, . . . , TSd#n) subjected to spreading codes and basic midamble;
a guard period (GP) opportunely long to avoid interference between the two way transmissions;
said randomly selected uplink synchronisation burst (SYNC1); and
a convenient number of m uplink data bursts (TSu#0, . . . , TSu#m) subjected to spreading codes and basic midamble.

14. A random access procedure according to one of the preceding claims, characterized in that a general synchronization is executed among all the base stations belonging to the cellular telephony system.
